(19) United States
(12) Patent Application Publication
(10) Pub. No.: US 2017/0057324 A1
(43) Pub. Date: Mar. 2, 2017

(54) MOTOR VEHICLE VENTILATION DEVICE

(71) Applicant: FORD GLOBAL TECHNOLOGIES, LLC, Dearborn, MI (US)

(72) Inventors: Ingo Krolewski, Neuss (DE); Sandra Krolewski, Neuss (DE)

(21) Appl. No.: 15/239,491

(22) Filed: Aug. 17, 2016

(30) Foreign Application Priority Data
Aug. 24, 2015 (DE) 102015216129.3

(51) Int. Cl. B60H 1/34; B60H 1/24

(52) U.S. Cl. CPC B60H 1/3414; B60H 1/242; B60H 2001/00635

(57) ABSTRACT

A motor vehicle ventilation device has at least one linear air duct which runs substantially horizontally inside a dashboard of the motor vehicle, and at least one air vent on the dashboard which is in fluidic connection with the at least one air duct. The at least one air vent is mounted moveably on the dashboard in the direction of the air duct. Means are provided which, independently of the selected position of the air vent, firstly maintain the fluidic connection between the air duct and the air vent and secondly keep the air duct closed substantially air-tightly outside the air vent.

### TECHNICAL FIELD

The document concerns a motor vehicle ventilation device with a linear air duct which runs substantially horizontally inside a dashboard of the motor vehicle, and with at least one air vent on the dashboard which is in fluidic connection with the at least one air duct.

### BACKGROUND

Such ventilation devices, with an air duct running horizontally in the dashbord and an air vent of practically the same length, as known from DE 197 53 877 A1 and DE 34 07 670 A1, and also from DE 10 2011 000 924 A1, in which a display input unit is guided moveably along a linear air vent.

In motor vehicles, an air vent is a component for emitting and guiding a controlled quantity of ambient air, or of heated or cooled air, into the vehicle interior. An air vent contains a type of grating which is usually formed by a number of adjustable air guide vanes or blades. Usually, several air vents are arranged distributed over the width of the dashboard, also called the instrument panel, e.g. one each on the left and right and one or two in the middle, in order to be able to meet the individual requirements of vehicle occupants for ventilation, heating and cooling.

In the prior art, the air vent—whether short or long—are always fixedly mounted on the dashboard and the vehicle occupants can vary the direction of the air flow as required by adjusting the air guide vanes from side to side and/or from top to bottom.

The motor vehicle ventilation device disclosed herein allows the use of fewer air vents and increases the variability of the ventilation.

### SUMMARY

The air vent according to the invention is mounted on the dashboard moveably in the direction of the air duct, wherein a sealing element or means is provided which firstly maintain the fluidic connection between the air duct and the air vent, and secondly keep the air duct closed substantially air-tightly outside the air vent, both independently of the selected position of the air vent.

Thus vehicle occupants can adjust not only the direction of the air flow but also the position of the air vent from which the air flow emerges, so as to allow better adaptation to the size, seating position, perception and needs of the individuals in the vehicle.

Also, such an air vent may replace two or more stationary air vents and takes up less space. Also new and sophisticated interior designs are possible which are not achievable with conventional air vents.

To maintain the fluidic connection between the air duct and the air vent, the air duct may have a linear slot along at least part of its length which opens towards the air vent, and to close the air duct outside the air vent, moveable or elastic elements may be provided for automatic closure of the part of the slot lying outside the air vent.

In particular, the sealing element or means for maintaining the fluidic connection between the air duct and the air vent and for closing the air duct outside the air vent may be formed in the manner of roller shutters or rubber lip seals.

In one possible embodiment, said slot and said moveable or elastic elements are arranged in a non-visible region of the dashboard, advantageously below a dashboard edge along which the air vent is mounted moveably. In other words, the air vent is formed as a slider which can be moved in the direction of the air duct on a guide integrated in the dashboard, preferably over approximately the length of the passenger half of the dashboard.

In one possible refinement, two or more air vents are provided which, while maintaining the fluidic connection with the at least one air duct, are moveable parallel to each other and independently of each other in the direction of the air duct. Preferably, two such air vents are provided, each of which can be moved over approximately the length of the passenger half of the dashboard.

The or each air vent can easily be moved by hand, but it is also possible to provide a motorized drive with which e.g. the driver of the vehicle can move a passenger-side air vent without having to reach for it.

### BRIEF DESCRIPTION OF THE DRAWING FIGURES

A description is given below of exemplary embodiments with reference to the drawings. These show:

FIG. 1 a perspective view of an air vent moveably arranged on a dashboard;

FIG. 2 an enlarged extract view of the air vent of FIG. 1;

FIGS. 3A and 3B perspective views of two moveable air vents arranged above each other in different positions;

FIGS. 4A and 4B a dashboard with one moveable air vent in perspective and in partial cross section;

FIG. 5 a longitudinal section view through an air duct and a moveable air vent with roller shutters as air closures; and

FIGS. 6A and 6B cross section views of an air duct sealed with rubber lips, once outside the air vent and once in the region of the air vent.

### DETAILED DESCRIPTION

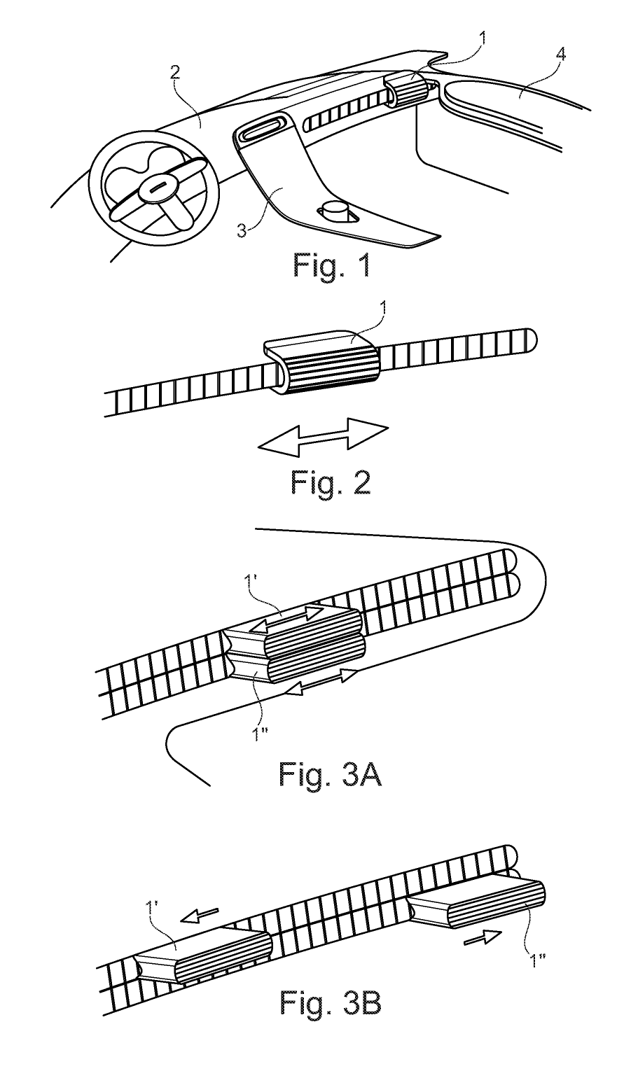

FIGS. 1 and 2 show an air vent 1 which is mounted on a motor vehicle dashboard 2 and moveable by hand horizontally along a dashboard 2 in a region between a center console 3 and a passenger door 4, as indicated with a double arrow in FIG. 2, so that a passenger can select his preferred position of the air vent 1. Alternatively, the driver of the vehicle may move the air vent 1 to the center console 3, and if desired adjust it so that air flows in his direction, e.g. if the ventilation from a driver's door-side air vent (not shown) is insufficient for him.

The air vent 1 is supplied with air via a linear air duct 5 which is concealed in the interior of the dashboard 2 and is at least as long as the air vent 1, such that independently of the selected position of the air vent 1, a fluidic connection exists between the air duct and the air vent 1, and the air duct remains closed substantially air-tightly outside the air vent 1.

In FIGS. 3A and 3B, two moveable air vents 1′ and 1″ are arranged in parallel directly above each other on the passenger-side dashboard 2, wherein each air vent 1′ and 1″ can be moved over the entire width of the passenger side, as indicated with a double arrow and single arrows respectively. Thus many different positions on the dashboard are possible and combinations thereof, two of which are shown as examples in FIGS. 3A and 3B.

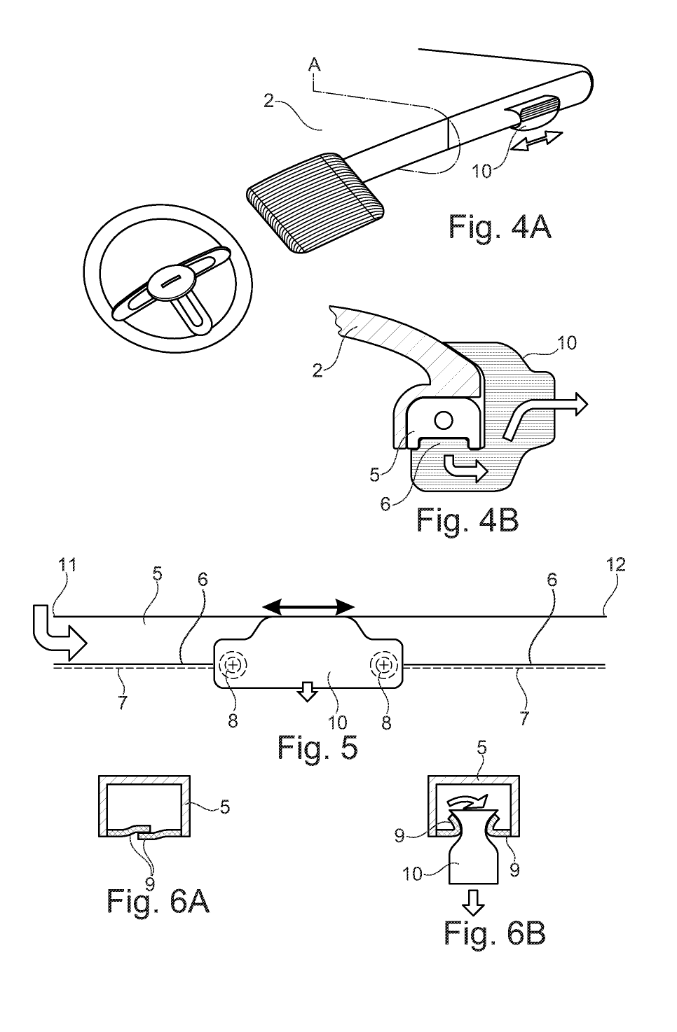

FIG. 4B shows a moveable air vent 10 in a cross section along dotted line A in FIG. 4A when the air vent 10 is in a position in which it lies inside the line A. As indicated with wide flow arrows, air flows out of an air duct 5 running in the dashboard 2 through a linear slot 6, which extends substantially over the entire length of the air duct 5 and which in this exemplary embodiment points down towards the footwell, down into the air vent 1 and then on into the vehicle interior.

FIG. 5 shows a longitudinal section view through the air vent 10 and the air duct 5 from the direction of a passenger seat, wherein the slot 6 in the air duct 5 is closed on the left and right of the air vent 10 by a sealing element such as a type of roller shutter 7, which rolls up and down on rollers 8 in the air vent 1 when the air vent 10 is moved along the double arrow (that is: generally along the Y-axis of the motor vehicle as per SAE vehicle axis system) between a first end 11 and a second end 12 of the air duct 5. Wide flow arrows indicate the air flow through the air duct 5 and the air vent 10. In this exemplary embodiment, the roller shutters 7 are not visible to the vehicle occupants because they are located on the underside of the dashboard, but they may also be arranged on the front of the dashboard and be visible to the vehicle occupants, as indicated in the exemplary embodiments of FIGS. 1 to 3. Instead of roller shutters 7, a slot in the air duct 5 may also be sealed outside the air vent 10 by means of a sealing element in the form of rubber lips 9, as illustrated in FIGS. 6A and 6B.

The person skilled in the art will note that there are many further sealing elements or means for keeping an air duct open at the selected position of a moveable air vent and closed outside this, e.g. in the manner of sliding doors or by means of bellows. Such means are also easy to implement because of the small pressure differences occurring and because it is not necessary to create absolute air-tightness.

What is claimed:

1. A motor vehicle ventilation device with at least one linear air duct that runs substantially horizontally inside a dashboard of a motor vehicle, and with at least one air vent on the dashboard which is in fluidic connection with the at least one linear air duct, wherein the at least one air vent is mounted on the dashboard moveably in a direction of the at least one linear air duct, and means that, independently of a selected position of the at least one air vent, firstly maintain the fluidic connection between the at least one linear air duct and the at least one air vent and secondly keep the at least one linear air duct closed substantially air-tightly outside the at least one air vent.

2. The motor vehicle ventilation device as claimed in claim 1, wherein said at least one linear air duct has a linear slot along at least part of a length of said at least one linear air duct that opens toward the at least one air vent.

3. The motor vehicle ventilation device as claimed in claim 2, wherein the means comprises moveable or elastic elements for automatic closure of the part of the linear slot lying outside the at least one air vent.

4. The ventilation device as claimed in claim 3, wherein the linear slot and/or the moveable or elastic elements are arranged in a non-visible region of the dashboard, in particular below a dashboard edge along which the at least one air vent is moveably mounted.

5. The ventilation device as claimed in claim 4, wherein the at least one air vent is moveable over approximately a length of a passenger half of the dashboard.

6. The ventilation device as claimed in claim 5, wherein two or more air vents are provided which, while maintaining the fluidic connection with the at least one linear air duct, are moveable parallel to each other and independently of each other in the direction of the at least one linear air duct.

7. The ventilation device as claimed in claim 6, wherein two such air vents are provided, each of which is moveable over approximately a length of a passenger half of the dashboard.

8. The ventilation device as claimed in claim 2, wherein the means is roller shutters.

9. The ventilation device as claimed in claim 2 wherein the means is rubber lip seals.

10. A motor vehicle ventilation device, comprising:
a linear air duct having a first end and a second end;
an air vent; and
a sealing element maintaining a fluidic connection between said air vent and said linear air duct as said air vent is displaced along said linear air duct between said first end and said second end.

11. The motor vehicle ventilation device of claim 10 wherein said linear air duct extends inside a dashboard of a motor vehicle generally along a Y-axis of said motor vehicle.

12. The motor vehicle ventilation device of claim 11 wherein said linear air duct has a linear air slot along at least part of a length of said linear air duct which opens toward said air vent.

13. The motor vehicle ventilation device of claim 12 wherein said sealing element closes a portion of said linear air slot lying outside said air vent.

14. The motor vehicle ventilation device of claim 13 wherein said sealing element is roller shutters.

15. The motor vehicle ventilation device of claim 13 wherein said sealing element is rubber lip seals.
